(19) United States
(12) Patent Application Publication
(10) Pub. No.: US 2011/0254250 A1
(43) Pub. Date: Oct. 20, 2011

(54) SWIVEL HEAD ASSEMBLY

(76) Inventor: Steven FORD, Ellensburg, WA (US)

(21) Appl. No.: 13/028,103

(22) Filed: Feb. 15, 2011

Related U.S. Application Data
(60) Provisional application No. 61/305,096, filed on Feb. 16, 2010.

(51) Int. Cl. B60D 1/00

(52) U.S. Cl. 280/494

(57) ABSTRACT

Various embodiments of the present invention comprise apparatus, assemblies and methods for towing a vehicle using a swivel head assembly. The swivel head assembly can permit a grid head of a towing system to roll as well as yaw with respect to a tow arm. Spring members are also provided that can help dampen roll motions.

### CROSS-REFERENCE TO RELATED APPLICATION(S)

This application claims the benefit of U.S. provisional patent application Ser. No. 61/305,096, filed Feb. 16, 2010, which is incorporated herein by reference in its entirety.

### BACKGROUND

1. Field of the Invention

The present invention relates generally to a swivel assembly for use in towing vehicles.

2. Description of Related Art

In the field of vehicle towing, substantial forces are exerted against towing systems that connect a towing vehicle to a towed vehicle. These forces can damage or “wear-down” equipment. It is thus desirable to reduce stress on the equipment.

### BRIEF SUMMARY OF THE INVENTION

In some embodiments of the present invention, a swivel head assembly is provided that allows a grid head used to attach the vehicle being towed to a towing arm to have rotation in two degrees of freedom. The grid head can swivel left or right when the towing vehicle makes a turn (yawing), and it can roll up to 30 degrees from horizontal when the towed vehicle has a roll angle with respect to the towing vehicle. Furthermore, the present invention dampens the motion associated with roll of the towed vehicle, which can help reduce vibration in the towing system.

### BRIEF DESCRIPTION OF THE DRAWINGS

FIG. 1 is a perspective view of an embodiment of the swivel head assembly of the present invention, also including a partial perspective view of an end portion of a towing arm.

FIG. 2 is a perspective view of a towing arm including the swivel head assembly of FIG. 1 attached thereto.

FIG. 3 is a perspective view of the swivel head and shaft of the swivel head assembly of FIG. 1, without showing a cassette of the swivel head assembly.

FIG. 4 is an exploded perspective view of the swivel head assembly of FIG. 1.

FIG. 5 is a side elevation view of the swivel head assembly of FIG. 1.

FIG. 6A is a top plan view of the swivel head assembly of FIG. 1.

FIG. 6B is a cross sectional view of the swivel head shown in FIG. 6A, along line 6B-6B.

### DETAILED DESCRIPTION OF PREFERRED EMBODIMENTS

In the following description, certain specific details are set forth in order to provide a thorough understanding of various embodiments of the invention. However, upon reviewing this disclosure, one skilled in the art will understand that the invention may be practiced without many of these details. In other instances, some well-known materials of construction, structures and methods of use and manufacture associated with towing arms, towing vehicles, and their related components, have not been described in detail to avoid unnecessarily obscuring the descriptions of the embodiments of the invention.

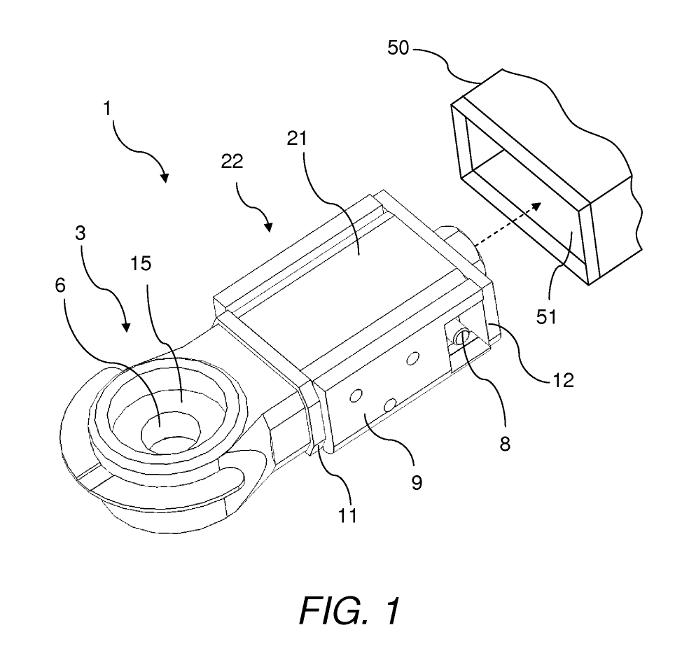

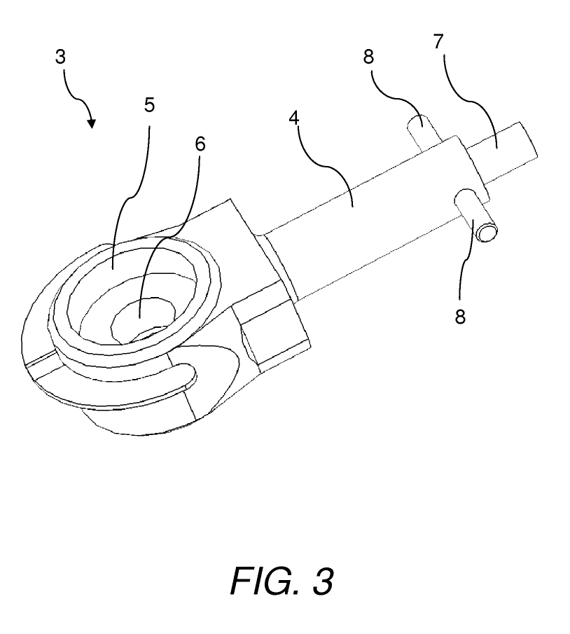

FIG. 1 illustrates an embodiment of a swivel head assembly 1 of the present invention, having a swivel head 3 with a shaft 4 (See, e.g., FIG. 3) encased within a cassette assembly 22.

As best seen in FIGS. 1 & 2, the swivel head assembly 1 can be connected to a towing arm 50, by insertion of the cassette assembly 22, or a portion thereof, into a chamber 51 of the towing arm 50, and securing the cassette assembly 22 to the towing arm 50 by, for example, without limitation, bolting or screwing the cassette assembly 22 to the towing arm 50. Both the cassette assembly 22 and towing arm 50 can have a generally rectangular lateral cross section, with the cassette assembly 22 being configured to fit within walls of the towing arm 50, to be attachable therein. As will be appreciated by those skilled in the art upon reviewing this disclosure, the towing arm 50 can be mounted on a towing vehicle by a mounting system 53, so that the towing arm 50 and swivel head assembly 1 may extend from the back of the towing vehicle.

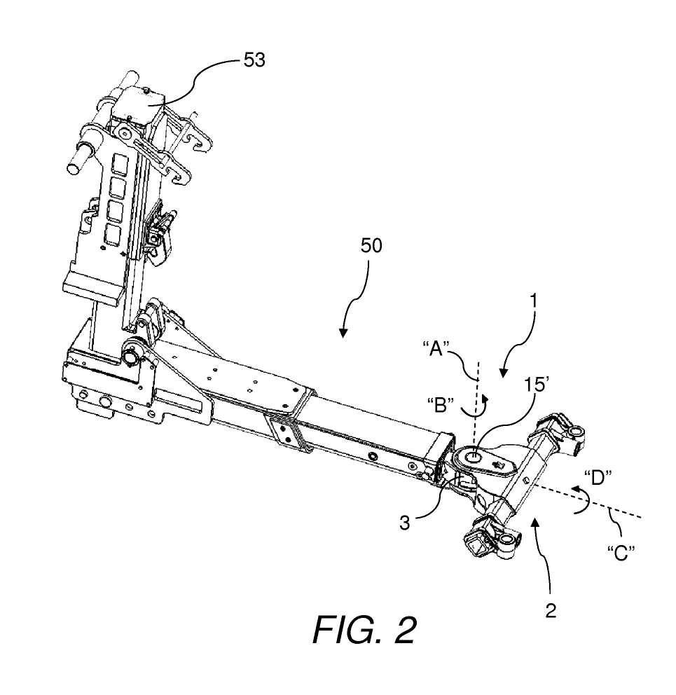

Also, as can be seen in FIG. 2, the swivel head 3 of the swivel head assembly 1 can be coupled to a grid head 2. The grid head 2 can be, in turn, connected to wheel cradles (not illustrated) or other attachment or retaining devices for coupling the towing vehicle (not illustrated) to a towed vehicle, as will be appreciated by those skilled in the art after reviewing this disclosure.

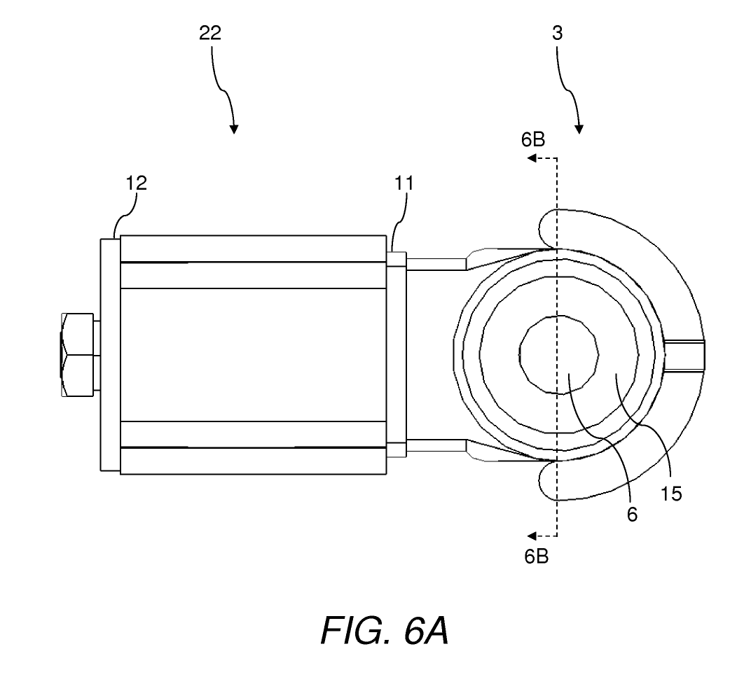

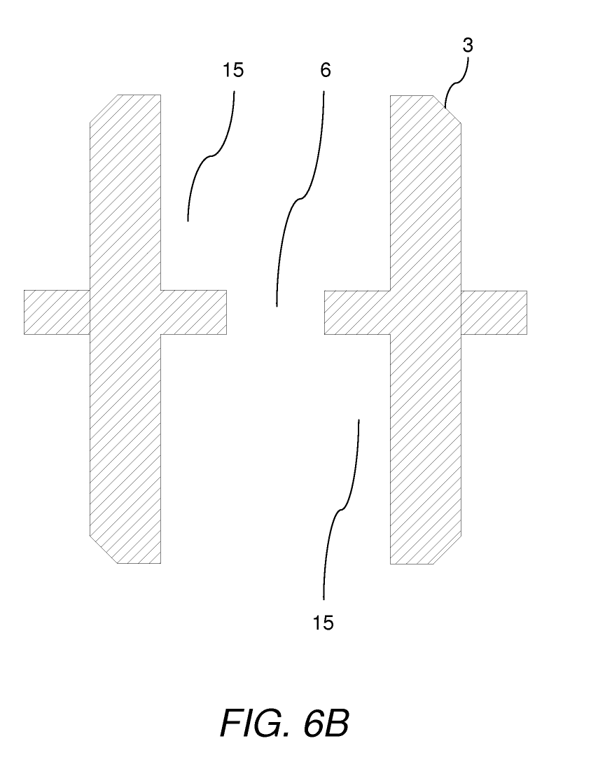

Referring to FIGS. 1, 6A & 6B, in some embodiments, the swivel head 3 contains two generally annularly shaped cavities 15, the cavities 15 being oppositely facing and including a top circular cavity 15 facing upward and a bottom circular cavity 15 facing downward. Furthermore, a hole 6 is provided through a wall between the cavities 15. The hole 6 can be concentrically located within the circular cavities 15. A rod 15′ (See, e.g., FIG. 2) can pass through the hole 6 to attach a grid head 2 to the swivel head 3. Bearings (not illustrated) can be included in the circular cavities 15 to help guide the rod 15′. Referring to FIG. 2, the grid head 2 can rotate, or pivot, about a vertical axis “A” of the rod 15′, in either direction, as roughly represented by the arrows “B,” thus providing a yaw feature to allow the grid head 2 to pivot in a horizontal plane as the towing vehicle turns.

As illustrated in FIGS. 3 & 4, the swivel head assembly 1 further includes a shaft 4 extending away from the swivel head 1. One end portion of shaft 4 is attached to the swivel head 3, while an opposite end portion of the shaft 4 includes a threaded connector 7. The threaded connector 7 can have a smaller radius than the shaft 4. Near the threaded connector 7, on the shaft 4, an aperture 4′can be provided through the shaft 4 for receiving a pin 8. The pin 8 can be inserted through the aperture 4′ such that end portions of the pin 8, protrude or extend outward on either side of the shaft 4 approximately equal distances from the shaft 4 (See, e.g., FIG. 3).

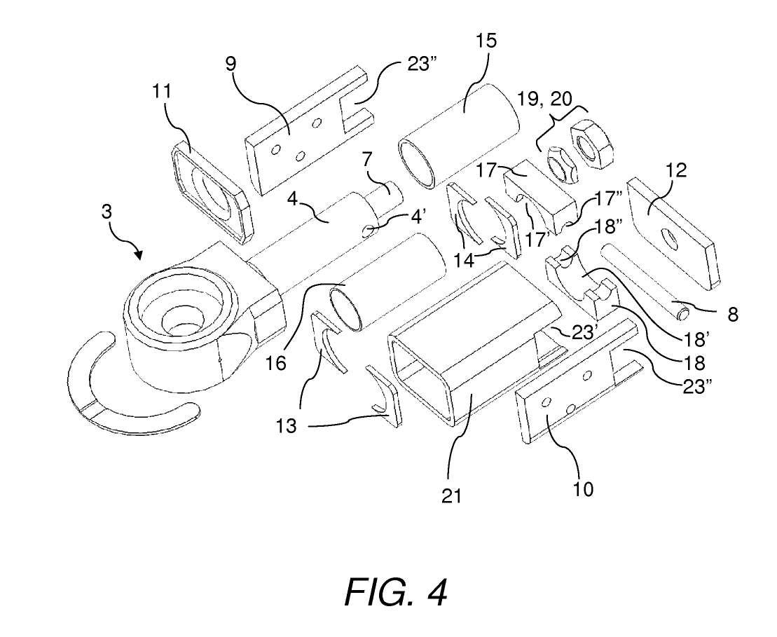

As best seen in FIG. 4, the cassette assembly 22 comprises a cassette base 21 having walls that form a generally rectangular cross, with a cavity contained therein defined by its walls. The sides of the cassette assembly 22 include side plates 9, 10, attachable to the cassette base 21. End plates 11, 12 can also be provided, the first end plate 11 having an aperture configured to receive the shaft 4, to allow the first end plate to slide over the shaft 4 until it abuts against a portion of the swivel head 3, and the second end plate 12 having an aperture configured to receive the threaded connector 7, to allow the second end plate to slide over the threaded connecter 7 until an end portion of the threaded connector 7 extends outwardly past the second end plate 12. A tubular bearing 16 can fit over the shaft 4 such that the shaft 4 is at least partially concentrically located within the bearing 16, and the bearing 16 can be, in turn, concentrically disposed within a circular tube 15. Both the bearing 16 and circular tube 15 are shorter in length than the shaft 4 such that they can avoid obstructing the aperture 4′ of the shaft 4. Pairs of end brackets 13, 14 can be provided, one pair disposed at each end of the cassette base 21. Each of the pairs of end brackets 13, 14 can be configured such that they can be mated together to provide circular openings to receive and retain the cylindrical tube 15. The end brackets 13, 14 can be located inside the cassette base 21 and may be welded in place. In some embodiments, all of the components of the cassette assembly 22 are retained between the end plates 11, 12, except end nuts (or other end retaining members) 19, 20, which can be securely attached to the threaded connector 7 to securely retain the end plate 12 against the rest of the cassette assembly 22, placing pressure on the cassette assembly 22 between the end plates 11, 12.

As further illustrated in FIGS. 4 & 5, the cassette base 21, the side plates 9, 10 together with the end plates 11, 12, define windows 23 on each side of the cassette assembly 22, though which opposite ends of pin 8 can extend and thus move. That is, for example, the cassette base 21 contains a cutaway window portion 23′ on each side thereof, on each of its vertical walls. Also, the side plates 9, 10 each have an edge cutaway window portion 23″, which can be aligned with corresponding cutaway window portions 23′ on the cassette base 21.

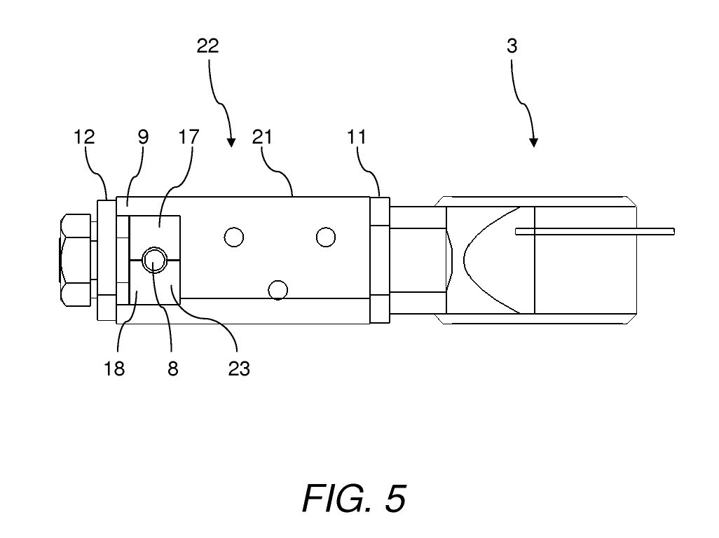

As best seen in FIGS. 4 & 5, spring members (or bumpers) 17, 18, are provided to mate with the end portions of the pin 8. That is, for example, an upper spring member 17 can have a centrally positioned bottom facing semi-circular concave curvature 17′ to fit snuggly over a top portion of the shaft 4 and can have one bottom facing semi-circle concave curvature 17″ formed on each of two side portions thereof to fit snugly over the top of end portions of the pin 8 (which extend laterally outward past the shaft 4). A high-point axis of the centrally positioned semi-circular curvature can be perpendicular to high-point axes of the semi-circular curvatures on the two side portions. Similarly, lower spring member 18 can have a centrally positioned upper facing semi-circular concave surface 18′ to fit snuggly over a bottom portion of the shaft 4 in a longitudinal direction, and can have one upper facing semi-circle concave surface 18″ formed on each of two side portions thereof to fit snugly over downwardly facing end portions of the pin 8 (which extend laterally outward past the shaft 4). A low-point axis of the centrally positioned semi-circular curvature can be perpendicular to low-point axes of the semi-circular curvatures on the two side portions. When the spring members 17, 18 are aligned and mated around the shaft 4 and pin 8, as shown in FIG. 5, the end portions of the pin 8 can be held snuggly between the spring members 17, 18.

The spring members 17, 18 may be made from different materials and are preferably made of urethane. Urethanes can have Shore ratings of, for example, 90A, 95A, 60D, and 65D, which may be suitable in various applications for various embodiments of the present invention. Furthermore, different spring members can be selected having different spring characteristics, such as, for example, without limitation, spring members having different hardness (Shore) ratings, or spring constants, depending upon the amount of dampening and the speed of return desired, as discussed further below.

Referring to FIG. 2, during towing, when the towing vehicle and towed vehicle travel over surfaces of differing surface contour resulting in different angles of roll between the towing vehicle and towed vehicle, the grid head can pivot about a longitudinal axis, to provide roll of the grid head 2 with respect to the towing arm 50. That is, for example, the swivel head 3 to which the grid head 2 is attached, can roll about the longitudinal axis “C” roughly in the direction of arrows “D,” with respect to the towing arm 50 and cassette assembly 22. This can allow the grid head to pivot about a longitudinal axis with respect to the towing arm 50.

When the grid head 2 pivots, or rolls, with respect to the towing arm 50, the shaft 4 can rotate about axis “C,” and the end portions of the pin 8 can move either up or down within the spring members 17, 18 to compress the spring members 17, 18. The spring members 17, 18 can bias the return of the pin 8 to a level position, or roughly zero roll position with respect to the towing arm 50. The speed of the return can be adjusted by using materials of different spring constants, as discussed above.

In some embodiments, when nuts 19, 20 are used to secure the shaft within the cassette assembly 22, they can be tightened to approximately 50 to 150 ft-pounds of torque. In some embodiments, once the swivel head assembly 1 has been assembled, the cassette assembly 22 can be received within the towing arm 50 and attached therein, such as by hex headed bolts.

In some embodiments, during operation, the swivel head 3 can roll up to, for example, 30 degrees from horizontal when the grid head 2 is not horizontal because, for example, the towing is being done over uneven terrain. The amount of roll can be adjusted up to approximately 30 degrees by varying the sizes of the window 23 form by the cassette assembly 22 walls, such that the pin 8 abuts against the edges of the windows 23, which serve as a stopping surfaces, when the roll angle is about 30 degrees from horizontal in either direction. As discussed above, the rate of return or dampening of roll motion or vibration can be adjusted by adjusting spring characteristics. In some embodiments, to avoid galling of shaft 4, it is preferable that end plate 11 is made from bronze, thereby allowing the swivel head assembly 1 to hold loads of up to approximately 100,000 pounds. Also, in some embodiments, bearing 16 can be made from a composite material. One such bushing is, for example, the POLYLUBE® MRP bushing available from Polygon Company.

Although specific embodiments and examples of the invention have been described supra (and in the attachments) for illustrative purposes, various equivalent modifications can be made without departing from the spirit and scope of the invention, as will be recognized by those skilled in the relevant art after reviewing the present disclosure. The various embodiments described can be combined to provide further embodiments. The described structures and methods can omit some elements or acts, can add other elements or acts, or can combine the elements or execute the acts in a different order than that illustrated, to achieve various advantages of the invention. These and other changes can be made to the invention in light of the detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A swivel assembly comprising:
a swivel head;
a shaft connected to the swivel head and disposed within an encasing body, the shaft being pivotable about a longitudinal axis with respect to the encasing body;
at least one protruding member extending laterally away from the shaft; and
at least one spring member disposed within the encasing body, the spring member being in contact with the at least one protruding member.

2. The swivel assembly of claim 1 wherein the at least one spring member is formed with at least one concave surface to receive the at least one protruding member.

3. The swivel assembly of claim 1 wherein the at least one protruding member is in contact with a spring member both on a top surface of the at least one protruding member and on a bottom surface of the at least one protruding member.

4. The swivel assembly of claim 1 wherein the encasing body includes a one or more windows and wherein the at least one protruding member can extend through the one or more of the windows.

5. The swivel assembly of claim 4 wherein a height of the one or more windows is selected such that the protruding member abuts against edges of the one or more windows only when the shaft pivots about thirty (30) degrees from horizontal.

6. The swivel assembly of claim 1 wherein the at least one spring member can be exchangeable with other spring members having different hardness.

7. The swivel assembly of claim 1 wherein the encasing body comprises end plates, with at least one end plate having an aperture through which the shaft can pass, and at least one end plate having an aperture through which a threaded connector disposed at an end of the shaft can pass.

8. A towing system comprising:
a swivel head connected to a grid head and capable of pivoting about a vertical axis with respect to the grid head; and
a shaft connected to the swivel head and capable of pivoting about a horizontal longitudinal axis with respect to a towing arm.

9. The towing system of claim 8 wherein the shaft is contained within an encasing body, with the encasing body being connected to the towing arm.

10. The towing system of claim 9 wherein the encasing body has vertical sidewalls with windows formed on the vertical sidewalls.

11. The towing system of claim 8 further comprising protruding members protruding from opposite sides of the shaft.

12. The towing system of claim 11 further comprising a spring member proximate each of the protruding members.

13. The towing system of claim 11 wherein the protruding members are opposite end portions of a pin passing through the shaft, and wherein each end portion of the pin is proximate a spring member to bias the pin against upward or downward movement.

14. The towing system of claim 11 wherein if the shaft pivots up to a particular angle, about the longitudinal axis, the protruding members will abut against stopping surfaces to prevent the shaft from pivoting further.

15. A swivel assembly comprising:
a swivel head pivotably connectable to a grid head;
a shaft extending from the swivel head and pivotably connected to an encasing body;
an elongated member connected to the shaft and extending laterally from the shaft;
at least one stopping surface formed on a window in the encasing body; and
wherein the elongated member extends through the window.

16. The swivel assembly of claim 15 further comprising at least one spring member disposed within the encasing body and disposed proximate an end portion of the elongated member.

17. The swivel assembly of claim 16 wherein when the shaft pivots about a longitudinal axis, the elongated member moves either upward or downward to compress the spring member, and the spring member biases the elongated member back to a horizontal position.

18. The swivel assembly of claim 15 wherein the elongated member extends through the shaft and wherein when the shaft pivots about a longitudinal axis, the elongated member can abut against the stopping surface.

19. The swivel assembly of claim 18 wherein the elongated member will not abut against the stopping surface when the shaft pivots less than thirty (30) degrees.

20. The swivel assembly of claim 15 further comprising a tow arm, and wherein the encasing body is inserted within the tow arm and wherein the encasing body comprises a first end plate through which the shaft extends, and a second end plate to which the shaft is connected by a threaded connector.

21. A method of towing a vehicle comprising:
providing a swivel head connected to a grid head, with the grid head being connected to a cradle device for towing a vehicle;
pivoting the swivel head about a vertical axis with respect to the grid head;
providing a shaft connected to the swivel head; and
pivoting the shaft about a horizontal longitudinal axis with respect to a towing arm.

22. The method of claim 21 further comprising biasing the shaft back to an original position after it has pivoted by biasing a protruding member that extends laterally away from the shaft and is coupled to the shaft.

23. The method of claim 21 further comprising stopping the shaft from pivoting past a pre-determined angle of roll by providing a laterally extending pin coupled to the shaft and abutting the pin against a stopping surface.
